(19) United States
(12) Patent Application Publication
(10) Pub. No.: US 2004/0206543 A1
(43) Pub. Date: Oct. 21, 2004

(54) Flexible cable arranged in rows

(76) Inventors: Yung-Tsai Chuo, Taichung (TW); Chang-Hsin Kuo, Taichung (TW)

Correspondence Address: APEX JURIS, PLLC, 13194 EDGEWATER LANE NORTHEAST, SEATTLE, WA, 98125, US

(21) Appl. No.: 10/414,621

(22) Filed: Apr. 16, 2003

(51) Int. Cl. H01B 7/00

(52) U.S. Cl. 174/117 F

(57) ABSTRACT

The present invention relates to a flexible, non guided cable for use with electric machinery or mechanical structures, and more particularly for a cable used to transmit the power and voltage signal to transfer air and oil.

### BACKGROUND OF THE INVENTION

1. Field of the Invention

This invention relates to a cable improvement. In order to avoid the crinkling of the cable, the cable of the present invention includes plural metal conductive wires and a pipe (for transferring air, oil or lubricant) arranged in rows. The strength of the cable is reinforced by a steel wire or spring piece, which has good elasticity, so that the cable will be restored to its original configuration after removing the external force to avoid the cable crinkling and to prevent plastic deformation.

2. Description of the Prior Art

In general, a power machine has a movable part and a fixed part where the power source is usually set at the fixed part of the power machine so that the cable for providing power does not need to bend or twist frequently and thereby minimizes damage to the cable. Therefore, the cable has high reliability. However, based on the requirement of the structure design, the signal checking wire of the location signal is usually connected to the movable part of the machine. Therefore, the signal checking wire is broken easily due to twisting. In some power machines, such as a linear motor, the cable (power cord) for providing power is connected to the movable part for the convenience in power design, so the cable, as well as the signal checking wire, are broken easily. In addition, in some machines, the pipes for transferring oil and air are set at the movable part to provide lubricant and reduce friction for the movable part. Therefore, when the movable part and the fixed part are in a complicated movement, the aforesaid wires and pipes crinkle easily.

FIG. 9 shows a design to avoid the winding of the wires and the pipes. A cable guiding 10 is used to guide the wire and the pipe of the machine, which include the transferring pipe 11 and the cable 12. The transferring pipe 11 can be used to transfer the air, oil or lubricant, and the cable 12 has the insulating material at the exterior side thereof, and plural electric wires in the interior thereof for transferring the voltage signal or electric power. The cable guiding 10 can guide the transferring pipe 11 and the cable 12 to move in a specific path so as to avoid winding. The aforesaid pipe 11 and the cable 12 are independent respectively, and are combined via the cable guiding 10. However, since the cable guiding 10 occupies a big space, the curvature is limited and the machine seems sluggish when moving fast.

Therefore, for the movable part of the conventional machine, the connecting manner of the cable should be improved to avoid the winding and crinkling of the wires and the pipes, and to reduce the breakage of the wires and pipes.

### SUMMARY OF THE INVENTION

It is an object of the present invention to provide a flexible cable used in the movable part of a moving machine.

It is another object of the present invention to provide a flexible cable which has good flexibility and which prohibits winding, crinkling and entanglement, so as to avoid breakage of the cable due to bending and twisting.

When the material is bent, the interior of the material will bear a stress and is strained. As shown in FIG. 10, when the material is bent, the strain is larger at the exterior side, and smaller at the interior. The stress and strain is increased as the degree of bending is increased which eventually surpasses the elastic limit of the plastic coating and thereby causes a resultant deformation of the plastic coating. Except to change the material and the winding design of the wire, another way to increase the flexibility is to reduce the thickness of the wire. FIG. 11 shows a conventional cable used to transfer the power or voltage signal. The insulating material 14 covers at the exterior side of the metal conductive wire 13 to prevent electrical leakage. The metal conductive wires 13 of the cable are arranged in rows, so that the thickness of the cable in one specific direction is obviously smaller, and therefore the cable has good flexibility. However, the elasticity of such cable is not good, so that the cable cannot restore to its original configuration after removing the external force, although it has good flexibility. Therefore, after the repeated movements of the movable part of the machine, the cable bears a heavy load and results in complicated deformation, and causes the wire to crinkle. In order to avoid crinkling of the cable, the cable of the present invention includes plural metal conductive wires and a pipe (for transferring air, oil or lubricant) arranged in rows. The strength of the cable is reinforced by the steel wire or spring piece, which has good elasticity, so that the cable can restore after removing the external force to avoid the cable winding for the plastic deformation.

### BRIEF DESCRIPTION OF THE DRAWINGS

The drawings disclose an illustrative embodiment of the present invention which serves to exemplify the various advantages and objects hereof, and are as follows:

FIG. 1 shows the flexible cable arranged in rows according to a first embodiment of the present invention;

FIG. 2 shows the flexible cable arranged in rows according to a second embodiment of the present invention;

FIG. 3 shows the flexible cable arranged in rows according to a third embodiment of the present invention;

FIG. 4 shows the flexible cable arranged in rows according to a fourth embodiment of the present invention;

FIG. 5 shows the flexible cable arranged in rows according to a fifth embodiment of the present invention;

FIG. 6 shows the flexible cable arranged in rows according to a sixth embodiment of the present invention;

FIG. 7 shows the flexible cable arranged in rows according to a seventh embodiment of the present invention;

FIG. 8 shows the flexible cable arranged in rows according to a eighth embodiment of the present invention;

FIG. 9 shows a conventional design to avoid the winding of the wires and the pipes;

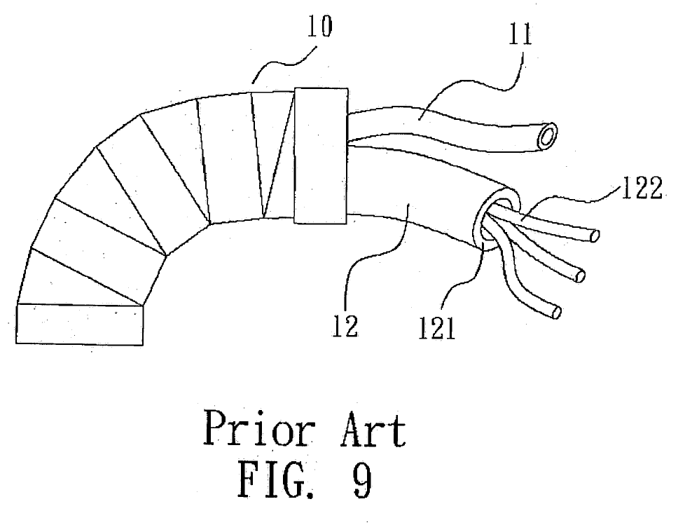

FIG. 10 shows the strain distribution when the material is forced; and

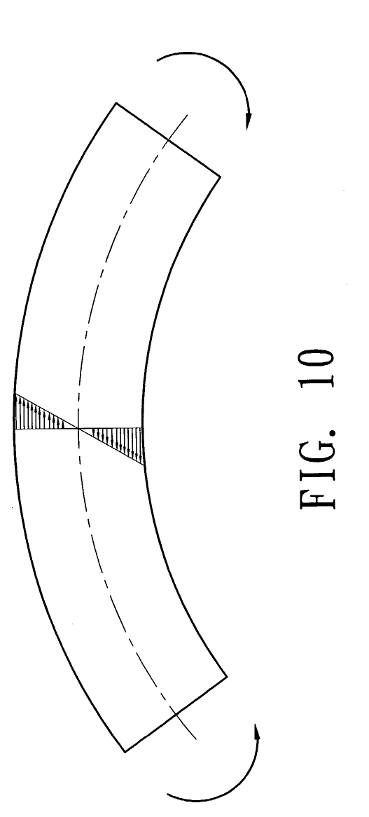

FIG. 11 shows a conventional cable.

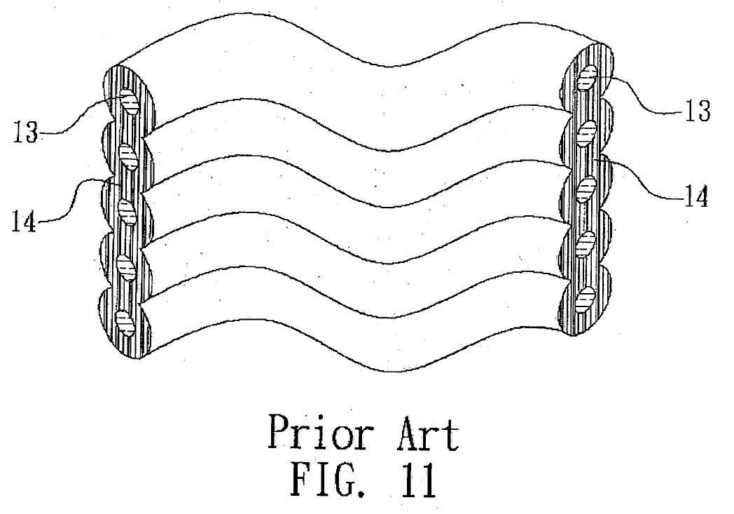

### DETAILED DESCRIPTION OF THE PREFERRED EMBODIMENT

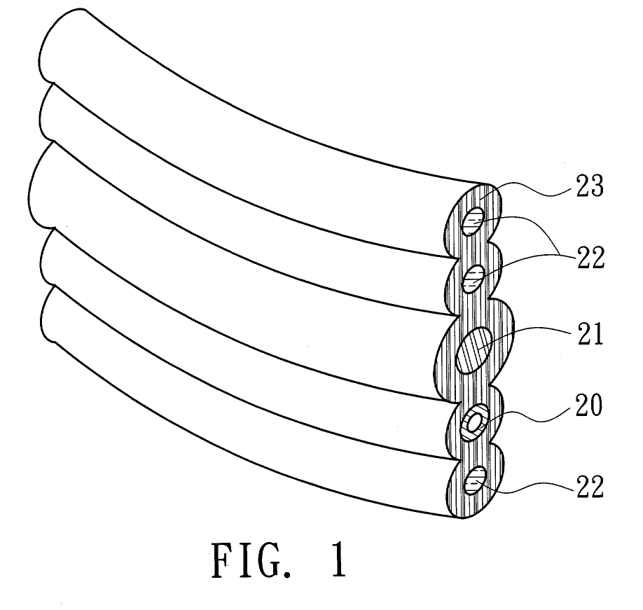

Please refer to FIG. 1 showing the flexible cable arranged in rows according to a first embodiment of the present invention. The flexible cable arranged in rows includes a pipe 20, a steel wire 22 and a metal conductive wire 22. The aforesaid pipe and wires are arranged in rows to reduce the strain or stress generated from the bending of the cable. An insulating material 23 covers at the exterior sides of the aforesaid pipe and wires. In this embodiment, the strength of the cable is reinforced by an elastic piece in the form of a long strip. The elastic piece is a steel wire 21. The pipe 20 is used to transfer the air and fluid, and the metal conductive wire 22 is used to transfer the voltage signal or electric power. In some examples, the pipe 20 for transferring the air and fluid is not needed. Therefore, the pipe 20 is not a necessary element. Since the steel wire 22 reinforces the strength of the cable, the cable can restore after removing the external force below the elastic limit. The rows arrangement of the steel wire 21, the pipe 20 and the metal conductive wire 22 make the cable have good flexibility.

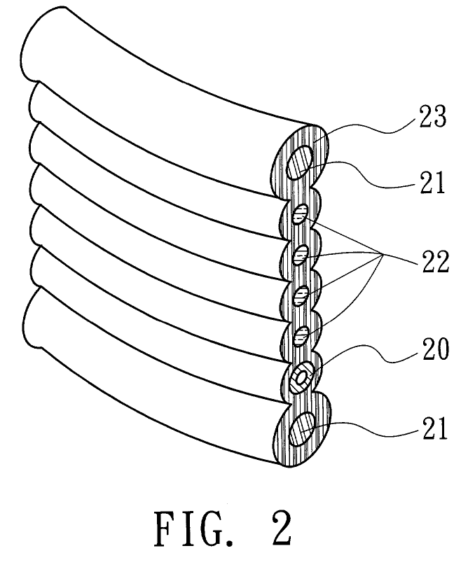

Please refer to FIG. 2 showing the flexible cable arranged in rows according to a second embodiment of the present invention. The cable also includes plural metal conductive wires, a pipe and steel wires, and the pipe 20, steel wires 21 and metal conductive wires 22 are arranged in rows. The insulating material 23 covers at the exterior sides of the aforesaid pipe and wires, and the two steel wires are arranged at the top and the bottom in the figure. Because the steel wires have good elasticity, when they are arranged at the two sides of the rows, the strength of the cable at the two sides can be reinforced. Therefore, when the cable is bent due to the external force, the bending radians at the two sides of the cable are close. There are four metal conductive wires 22 and one pipe 20 in this embodiment, but the numbers of the metal conductive wire 22 and the pipe 20 are changeable in accordance with the actual need.

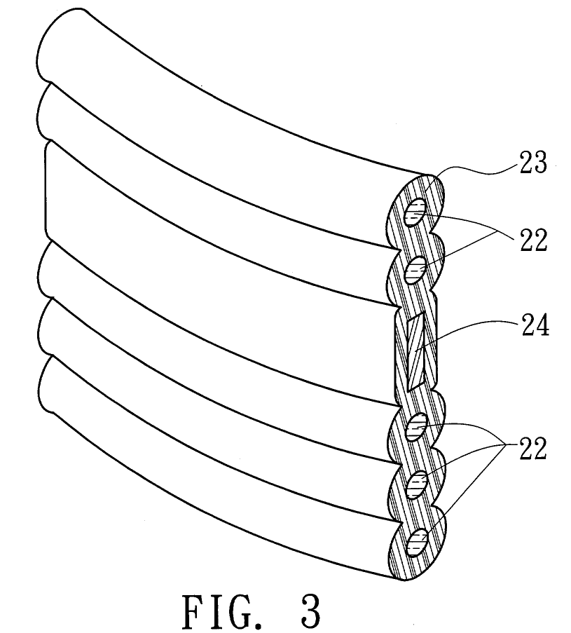

Please refer to FIG. 3 showing the flexible cable arranged in rows according to a third embodiment of the present invention. The cable also includes plural metal conductive wires 22. In this embodiment, the strength of the cable is reinforced by an elastic piece, which is a spring piece 24 in the form of a thin slice. The metal conductive wires 22 and the spring piece 24 are arranged in rows. The insulating material 23 covers the exterior sides of the aforesaid wires and spring piece. The thinner side of the spring piece 24 is arranged along the thinner side of the cable. Therefore, the flexible cable arranged in rows of the present invention has good flexibility, and the bending radians at the two sides of the cable are close. There are five metal conductive wires 22 and no pipe in this embodiment, but the pipe can also be set when needed.

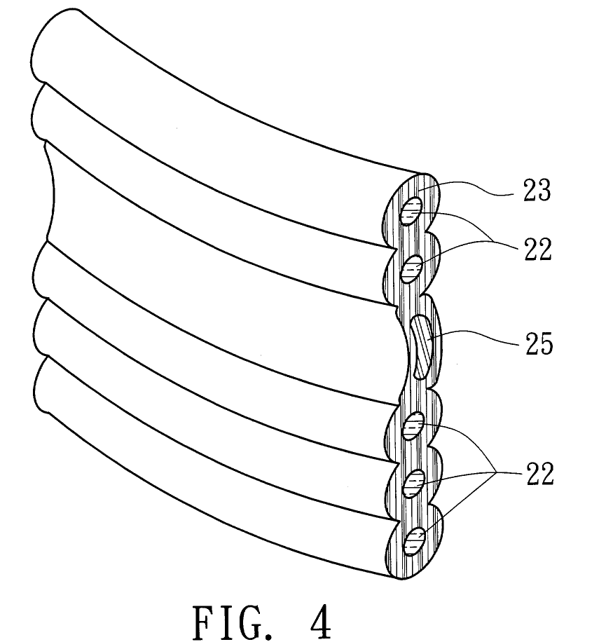

Please refer to FIG. 4 showing the flexible cable arranged in rows according to a forth embodiment of the present invention. In this embodiment, the strength of the cable is reinforced by an elastic piece, which is a spring piece 25 having a cross-section of an arc. The arc design of the spring piece 25 can increase the anti-flexibility of the cable, so that the cable is approximately a straight line when it is not bent by the external force. On the other hand, since the spring piece 25 can be designed with a thinner thickness, when the cable has to be bent, the cable can be designed to conform to the bending force requirements. In this embodiment, the metal conductive wires 22 and the spring piece 25 are arranged in rows. The insulating material 23 covers the exterior sides of the aforesaid wires and spring piece. There are five metal conductive wires 22 and no pipe in this embodiment, but the pipe can also be set when needed.

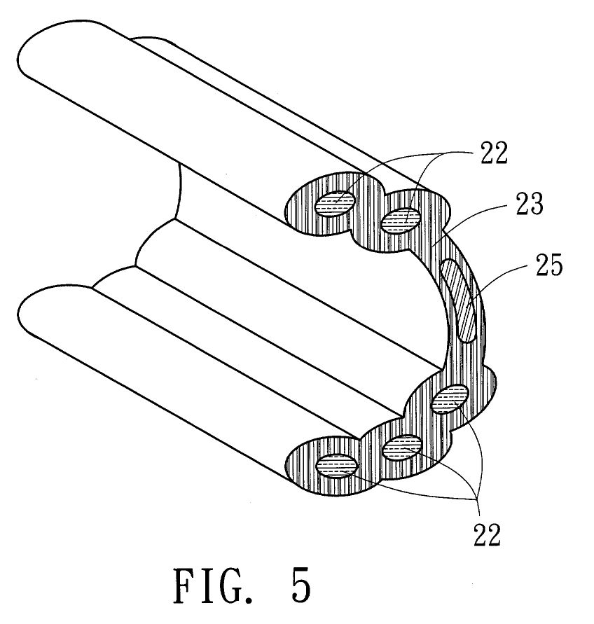

Please refer to FIG. 5 showing the flexible cable arranged in rows according to a fifth embodiment of the present invention, which is a modification of the fourth embodiment. This embodiment provides a better anti-flexibility when the cable is not bent and it is desired to keep it as a straight line.

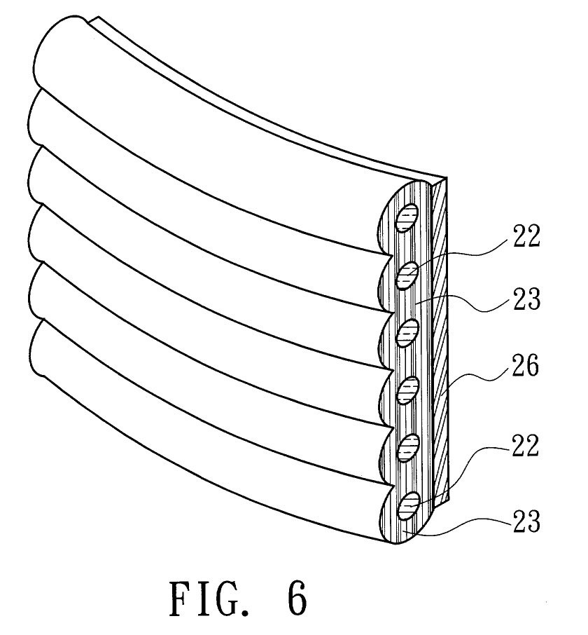

Please refer to FIG. 6 showing the flexible cable arranged in rows according to a sixth embodiment of the present invention. The metal conductive wires 22 are arranged in rows. The insulating material 23 covers the exterior sides of the aforesaid metal conductive wires 22. The spring piece 26 for reinforcing the strength of the cable is set close and adjacent to one side of the insulating material 23. The cross-sectional length and width of the spring piece in FIG. 6 are changeable in accordance with flexible elasticity requirement.

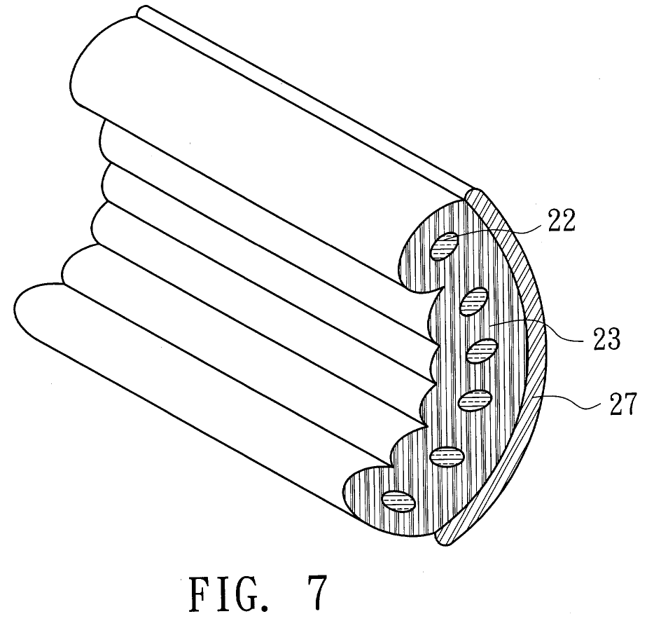

Please refer to FIG. 7 showing the flexible cable arranged in rows according to a seventh embodiment of the present invention, which is a modification of the fourth (Sixth???) embodiment. In this embodiment, the metal conductive wires 22 are arranged in rows but with a small radian. The insulating material 23 covers the exterior sides of the aforesaid metal conductive wires 22. The spring piece 27 for reinforcing the strength of the cable is set close to one side of the insulating material 23. In this embodiment, since the metal conductive wires 22 are arranged in rows but with a small radian, and the spring piece 27 is also an arc, the cable has an excellent anti-flexibility.

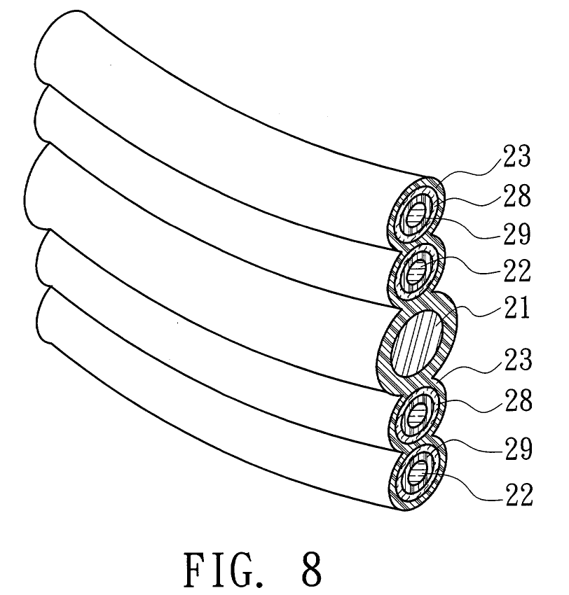

For avoiding electromagnetic interference, the signal wire is generally covered with a layer of isolated metal net. In addition, the conductive wire for transferring power has a high current value, and causes a strong electric field which may interfere with the signal wires in the neighborhood. Therefore, the conductive wire is also generally covered with an isolated metal net to avoid the signal interference. Accordingly, the metal conductive wire 22 in the aforesaid embodiments can be also covered with the isolated metal net. FIG. 8 shows the flexible cable arranged in rows according to an eighth embodiment of the present invention. In this embodiment, the metal conductive wire 22 is covered with a layer of insulating material 29, and the insulating material 29 is covered with a layer of an isolated metal net 28, and furthermore, the isolated metal net 28 is covered with the insulating material 26 to avoid electric leakage.

Therefore, the flexible cable arranged in rows of the present invention has the following advantages:

1. The flexible cable has good flexibility in some specific directions due to the design of the row arrangement.

2. The strength of the flexible cable is reinforced by a spring piece or a steel wire. Therefore, the cable will not crinkle and will not cause the complicated plastic deformation, and there is no need to set the cable guiding outside of the cable.

3. The flexible cable includes plural conductive wires and a pipe to comply with the requirements of the movable part of a general machine. In addition, it can be designed to have the function of electromagnetic interference isolation, so it is convenient to use.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A flexible cable arranged in rows, comprising:
plural metal conductive wires being good conductors and arranged in rows mutually;
an insulating material covering at an exterior side of said metal conductive wires; and
an elastic piece being a long strip and adjacent to said insulating material, wherein said elastic piece is made of steel and has good elasticity to reinforce the strength of said cable, so that said cable restores after removing the external force below the elastic limit;
wherein said elastic piece is a spring piece;
wherein said spring niece and said metal conductive wires are arranged in a single row.

2-6. (canceled)

7. The flexible cable according to claim 1, wherein the cross-section of said spring piece is an arc when cable is not bent, so that said cable is approximately a straight line when it is not bent by the external force.

8. The flexible cable according to claims 1 or 7 wherein a pipe is set beside said metal conductive wire, and said pipe and said metal conductive wires are arranged in rows.

9. The flexible cable according to claims 1 or 7, wherein said metal conductive wires are covered with an isolating metal net.
